(19) United States
(12) Patent Application Publication
(10) Pub. No.: US 2009/0000733 A1
(43) Pub. Date: Jan. 1, 2009

(54) METHOD AND DEVICE FOR APPLYING A FILM TO A CARRIER

(76) Inventor: Anders Berndtsson, Stein am Rhein (SZ)

Correspondence Address: Lauson & Tarver LLP, 880 Apollo Street, SUITE 301, El Segundo, CA, 90245, US

(21) Appl. No.: 12/144,521

(22) Filed: Jun. 23, 2008

(30) Foreign Application Priority Data
Dec. 23, 2005 (DE) 10-2005-062-396.4

(51) Int. Cl. B32B 37/12; B32B 38/00

(52) U.S. Cl. 156/275.7; 156/379.6

(57) ABSTRACT

An improved process of adhering a film to a carrier substrate, including cards of any type, provides a carrier comprising the card, including the information printed on the card, and any other flat objects provided with the card, and provides a film, wherein a transparent adhesive is disposed between the film and the carrier, either as a separate layer, or incorporated into the side of the film facing the carrier. Once the adhesive is brought into contact with the carrier and the film, irradiation from an electromagnetic wave source, including a light source, and further including an ultraviolet light source is applied to the assemblage to cause the adhesive to set.

### CROSS-REFERENCE TO RELATED APPLICATION

This application claims the benefit of the priority filing date of international application no. PCT/DE2006/001965, and German application no. (DE)10-2005-062-396.4 filed Dec. 23, 2005.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a method for applying a film to a carrier, with the carrier being a substrate of whatever type, for example, a plastic card. The carrier is irreversibly coated at least partially by the film. In addition, the invention relates to a device for applying a film onto a carrier, especially in connection with the invention-specific method.

More specifically, the invention relates to the processing of any flat carrier or substrate that is at least partially covered or coated to protect information contained on it. These can be so-called “plastic cards,” as are used, for example, as permanent access cards with additional magnetic strips, transponders, or the like. Various institutions and organizations use such cards, for example, banks, video stores, book clubs, fitness centers, etc.

Normally, these types of cards are printed with any kind of information; in the simplest case, using printers or copiers. It should be noted that the carriers do not absolutely have to be plastic cards. In the simplest case, these can be paper or cardboard cards that are printed and then covered or laminated in plastic.

The prior art is sufficiently well known in practice. Customarily, after being printed and/or equipped with other optically, and/or electronically readable information, the carrier is covered by a transparent film. To apply this film irreversibly onto the carrier, a process is used according to which transparent melting glue acts adhesively at high temperatures between the carrier and the film. In most cases, the transparent glue is on the film, which is pressed onto the carrier while applying heat and pressure.

However, the use of relatively high temperatures is problematic in practice because, often, the adhesion achieved is insufficient due to the contact surface energy employed. In addition, automatic manufacturing can be delayed due to heating and cooling processes. In both heating and cooling, there are time-critical procedural steps that add considerable expense to making of the film carrier. A laminated carrier or a coated plastic card can be handled only after cooling. When manufactured individually, such as in video stores, this is problematic because heating and cooling involves considerable waiting time. When using heat, there is the additional danger of injury if the device laminating or covering the carrier is improperly used. Finally, the energy consumption of these devices is considerable.

The objective of the present invention, therefore, is to configure and further develop both a method and a device of the type known from practice that can manufacture a laminated or film covered carrier with less station time and with avoidance of the above-mentioned problems. In addition, according to the invention-specific method, it is possible to apply the film irreversibly to the carrier so as to make it harder to counterfeit.

### SUMMARY

The invention relates to a method for applying a film to a carrier, with the carrier being a substrate of any type, for example, a plastic card. The carrier is irreversibly coated at least partially by the film. In addition, the invention relates to a device for applying a film onto a carrier, especially in connection with the invention-specific method.

The carrier to be coated or covered at least partially with the film is prepared. The carrier can be a substrate of any type, such as a card or plastic card. The carrier can be made available from a storage device or depository, as needed, from which it is delivered.

It is essential that the carrier and film, in any geometric arrangement, be brought together. When combined, a bonding takes place between the film and the carrier, with the adhesive hardening due to the action of electromagnetic waves (light action), instead of heat.

Printing technology is used to apply the adhesive to the carrier or to the film, or to both the carrier and film. It is also conceivable to use an irradiation process to apply the adhesive, preferably an irradiation process similar to the so-called ink jet process in ink jet printers. The adhesive can be applied at a special gluing station.

The present invention-specific device comprises a gluing station, a joining station, and a hardening station.

The film serving to coat the carrier is made available via a film band that is unrolled from the roll serving as a supply of the film. From there, the film band or the film found on it goes directly to the joining station.

The carrier is fed in linear fashion to the gluing station, is covered using printing technology on its surface by the transparent adhesive, and from there, is fed from the joining station in which the carrier is combined with the film.

After the film is applied to the carrier (with the adhesive found between them), the arrangement thus produced is compressed.

Then, in the hardening station, an ultraviolet light source irradiates the film. There, the adhesive hardens while the film is bound onto the carrier, so that in a separating station that follows, the film band is able to be lifted off the film or the carrier, by deflection. From there, the film band goes to a roller, with which the rolled-up film band can be disposed of. The carrier coated with the film is fed onward for further processing and/or manipulation.

### FIGURE

FIG. 1 is a diagram of the device involved in applying a film to a carrier, and illustrates the method thereto.

### DESCRIPTION

The problems noted above are solved according to the invention with the features of patent claim 1. In addition, the previously mentioned problems are solved by a device with features of patent claim 29.

In accordance with the features of patent claim 1, the invention-specific method is characterized by the following procedural steps:

First, the carrier to be coated or covered at least partially with the film is prepared. The carrier, as discussed above, can be a substrate of any type, such as a card. The card can be a plastic card. The carrier can be made available from a storage device or depository, as needed, from which it is delivered.

In the next step, the carrier or film is coated with a thin layer of a transparent adhesive, with the adhesive being hardened by the action of electromagnetic waves. It is conceivable that the adhesive can also be a two-component glue, and whereby the two components can react with each other due to the action of electromagnetic waves.

Alternatively, it is conceivable to prepare a film that is already coated with the transparent adhesive, and then also the adhesive is hardened by the action of electromagnetic waves.

Here, it should be noted that fundamentally the adhesive hardens due to the action of electromagnetic waves, especially by the action of light. In drawing a distinction from hardening due to temperature action, it should be noted that, here, the action is without an increase in temperature, or with only a slight temperature increase. To that extent, the procedure differs from the customary procedure of using high temperatures.

It is essential that the carrier and film, in whatever geometric arrangement, be brought together. When combined, a bonding takes place between the film and the carrier, with the adhesive hardening due to the action of electromagnetic waves. The carrier is irreversibly coated with the film, whereby the information found on the carrier is visible through the transparent film.

Here, it should further be noted that the adhesive may be a glue of any type that, for example, hardens due to light action. Thus, the adhesive may be glue that more or less hardens in a cold state, in contrast to the applications known from practice, according to which the adhesive hardens due to temperature effect.

Additionally, it is conceivable that the film covers the carrier fully, i.e., over the entire surface. However, it is also possible to apply the film only onto certain areas of the carrier. Also, appropriate patterns and contours can be implemented with the material of the film. In addition, the film can be applied to recesses on the carrier, in accordance with the particular need.

In a preferred embodiment, printing technology is used to apply the adhesive to the carrier or to the film, or to both the carrier and film. The rotational printing process, preferably flexor printing, can be used as the printing process. Also screen printing can be considered as the printing process.

It is also conceivable to use an irradiation process to apply the adhesive, preferably an irradiation process that is similar to the so-called ink jet process in ink jet printers.

The adhesive can be applied at a special gluing station. In this case, it is better to feed the carrier in linear fashion to the gluing station to provide full-surface application of the adhesive on the side to be coated or covered with film. Thereafter, or alternatively, the carrier is again fed in linear fashion to a joining station placed after the gluing station, wherein the film is applied to the carrier under the action of the adhesive.

With regard to the film, it may be made available continuously as a band of film. The film that serves for covering can be applied to the film band in a proportional or dimensional fashion. Correspondingly, the film band bearing the film may be fed to the gluing station for coating with the adhesive so that the adhesive is applied there. This can take place instead of, or be in addition to applying the adhesive onto the carrier.

In a next step, the film—in one preferred embodiment, continuous as a film band—is fed to the joining station to cover the carrier on top or underneath. In this regard, it should be noted that it is also possible to feed a film via a film band to the joining station on both sides of the carrier in order to produce a bilateral coating of the carrier with film. In any case, it is advantageous if the film, via a band-forming film carrier, is fed if possible first to the gluing station and then to the joining station. The film placed on the film carrier could be unrolled from a roll that serves as a supply source and, if necessary, thereafter fed through the joining station.

Once again, it should be noted that for gluing the carrier and film, an adhesive is used that hardens under the action of electromagnetic waves, especially under light action. For the moment, it makes no difference where and how the adhesive is applied. It is also conceivable that the adhesive is already on the film surface, namely, on the side facing away from the film carrier and facing the carrier, so that the film already provided with the adhesive, is unwound from the roll and fed to the joining station.

In a further step, the arrangement of the carrier and film, and the adhesive found between them, is compressed by at least slight pressing force. For pressing, pairs of rollers placed opposite one another, or also flat pressing stamps can be used. After, or during pressing, or between the individual steps of pressing, the arrangement of the carrier with the film applied to the carrier and the adhesive found between them is preferably subjected to irradiation by electromagnetic waves, especially by light, through the film carrier and the film. Ideally, ultraviolet light is used for irradiation. It is also conceivable to first harden the adhesive only partially and thereafter again, to press the arrangement and undertake an additional irradiation, and thus a final hardening. Any combination of sequences of these individual operational steps is conceivable.

The film can be made available in individual pieces so that they may be individually fed to the gluing station and/or the joining station.

If the film for coating is made available via a film carrier, then it is particularly advantageous if before, during, or after hardening of the adhesive, the film carrier is lifted off the film attached to the carrier. Thus, the film carrier can be lifted off as an endless band from the arrangement or from the carrier, and be wound up on a following roll for the purpose of disposal. The coated carrier is simultaneously pushed further along, preferably in linear fashion, for further manipulation and/or processing.

Additionally, it is conceivable that prior to being applied to the carrier, the film is processed. Thus, the film could be laser-treated, perforated, stamped or treated in some other manner. It is especially conceivable that prior to being applied to the carrier, the film is printed on, preferably on the side facing the carrier.

As mentioned before, it is customary for the carrier to be equipped with information by printing technology that is to be protected by the film. Thus, it is possible, before the carrier and film are combined, but most of all before the carrier is coated with the adhesive, to print on the carrier in whatever manner, or to equip it with electronic information. Alternatively, or additionally, it is conceivable that the film serving as the coating is printed on before application to the carrier, preferably on the side facing the carrier. This information can supplement the information found on the card, or be provided instead of it. It is also conceivable that between the carrier and the film—before the combining of the carrier and film—flat pieces that are as thin as possible are inserted or positioned and fixed by the film onto the carrier. The arrangement of any flat pieces is conceivable, for example, the placement of a picture, an extremely thin electronic circuit, a coil, etc.

According to the method described above, an invention-specific device, according to patent claim 29, serves especially for implementing the previously described method. Such a device comprises a gluing station, in which the carrier and/or the film is at least partially covered with a thin layer of a transparent adhesive that hardens under the effect of electromagnetic waves. Additionally, part of the device is a joining station in which the carrier and the film are brought together. In a hardening station that is next to it, the adhesive hardens under the influence of electromagnetic waves.

For making the carrier available, in an advantageous fashion, a storage device is provided from which the carrier preferably can be delivered in linear fashion to the stations.

For making the film available, a supply, preferably embodied as a roll, is provided, from which the film preferably can be unrolled on a band-shaped film and fed to the stations. An additional roller is provided for disposal of the film carrier, which serves as a depository. After being taken off the glued-on film, the film carrier can be rolled up onto this roll and can be disposed of with the roll.

As already explained, for the invention-specific method, a processing station can be provided in which the film is, for example, laser-treated, perforated, stamped or treated in some other way. Likewise, a printing station can be provided that serves for printing on the carrier and/or the film. This printing station is to be placed before the gluing station and before the joining station.

It should additionally be noted that owing to a special feeding of carrier and film, complete or partial coating of the carrier by the film can be realized, namely by deliberately feeding the carrier and the film in staggered fashion into the joining station and appropriately combining them, partially covering each other. In addition, it should be noted also that the carrier or the substrate can be fed in the form of an endless band that is cut before or while in the joining station. Likewise, it is conceivable to make the carrier or substrate available on a band-shaped carrier, already pre-manufactured.

There are various possibilities to embody and further develop the teaching of the present invention. In this regard, reference is made, on the one hand, to the patent claims placed after patent claim 1, and, on the other hand to the following explanation of an embodiment example of the invention using the drawing. In connection with the explanation of the preferred embodiment example of the invention using the drawing, generally preferred embodiments and further developments of the teaching are also explained.

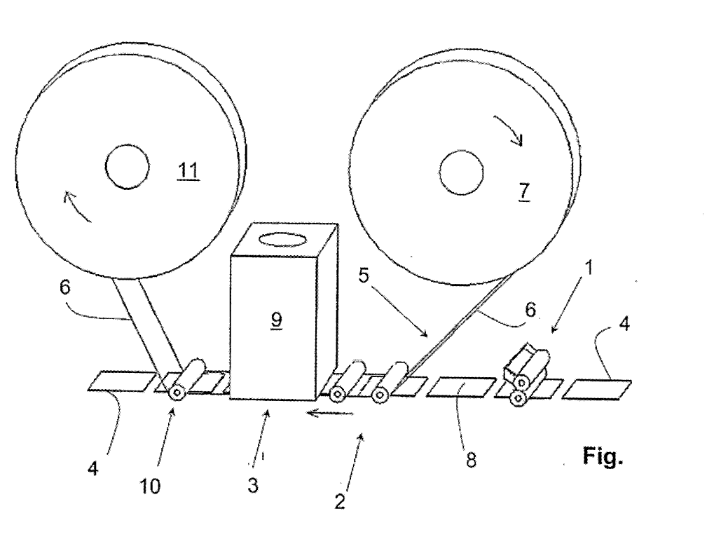

According to FIG. 1, the invention-specific device comprises a gluing station 1, a joining station 2, and a hardening station 3.

Additionally, FIG. 1 reveals that the film 5 serving to coat the carrier 4 is made available via a film band 6 that is unrolled from the roll 7 serving as a supply of the film 5. From there, the film band 6 or the film 5 found on it goes directly to the joining station 2.

In the embodiment form shown here, the carrier 4 is fed in linear fashion to the gluing station 1, is covered using printing technology on its surface by the transparent adhesive 8, and from there, is fed from the joining station 2 in which the carrier 4 is combined with the film 5.

After the film 5 is applied to the carrier (with the adhesive 8 found between them), the arrangement thus produced is compressed.

Then, in the hardening station 3, an ultraviolet light source 9 irradiates the film. There, the adhesive 8 hardens while the film 5 is bound onto the carrier 4, so that in a separating station 10 that follows, the film band 6 is able to be lifted off the film 5 or the carrier 4, by deflection. From there, the film band 6 goes to a roller 11, with which the rolled-up film band 6 can be disposed of. The carrier 4 coated with the film 5 is fed onwards for further processing and/or manipulation.

In regard to the further features that cannot be gleaned from FIG. 1, to avoid repetition, we refer to the general part of the specification and to the patent claims.

Finally, it should be noted that the embodiment example explained above serves as an exemplary explanation of the claimed teaching, but does not limit this to the embodiment example.

What is claimed is:

1. A process for applying a film to a carrier substrate, including a plastic card, wherein the carrier is at least partially coated irreversibly with the film, characterized by the following steps:
a. making the carrier available;
b. Coating the carrier or the film with a thin layer of a transparent adhesive that hardens under action of electromagnetic waves, or making available a film coated with a thin layer of a transparent adhesive that hardens under the action of electromagnetic waves;
c. uniting the carrier and film, and;
d. hardening the adhesive under the action of electromagnetic waves, including light action.

2. The process of claim 1, wherein the film is applied to the entire substrate surface, in section, or in patterns, or with cutouts, onto the carrier.

3. The process of claims 1 or 2, wherein the adhesive is applied by printing technology onto the carrier or onto the film.

4. The process of claim 3, wherein a roll rotation process, preferably flexoprinting, is used as the printing process.

5. The process of claim 3, wherein screen printing is used as the printing process.

6. The process of claim 3, wherein a jet process, preferably similar to the ink jet process, is used as the printing process.

7. The process of claims 1 through 6, wherein the adhesive is applied in a gluing station.

8. The process of claim 7, wherein the carrier is fed in linear fashion to the gluing station for coating with adhesive.

9. The process of claims 1 through 8, wherein the carrier is preferably fed in linear fashion to a joining station, placed after the gluing station if necessary.

10. The process of claims 7 through 9, wherein the film is fed in individual pieces to the gluing station for coating with adhesive.

11. The process of claims 7 through 9, wherein the film is fed continuously as a film band to the gluing station for coating with the adhesive.

12. The process of claims 7 through 11, wherein the film is fed in individual pieces to the joining station for the carrier to be covered on either side of the carrier.

13. The process of claims 7 to 11, wherein the film, as a film band, is fed to the joining station for the carrier to be covered on either side of the carrier.

14. The process of claims 7 through 13, wherein the film is fed via a band-shaped film carrier to the gluing station and to the joining station.

15. The process of claims 7 through 14, wherein the film is unrolled from a roll serving as a supply, and is fed to the gluing station and to the joining station.

16. The process of claims 7 through 15, wherein the film is coated by the adhesive on the side facing away from the film carrier and on the side facing toward the carrier.

17. The process of claims 1 through 16, wherein the arrangement of the carrier, the film applied to the carrier, and the adhesive between them is compressed with a compression force.

18. The process of claims 1 through 17, wherein the arrangement of the carrier, the film applied to the carrier, and the adhesive found between them is subject to irradiation with electromagnetic waves, including through the film carrier and the film, and including by light.

19. The process of claim 18, wherein ultraviolet light is used for the irradiation.

20. The process of claims 1 through 19, wherein before, during, or after the hardening of the adhesive, the film carrier is lifted off the film bound to the carrier.

21. The process of claim 20, wherein after removal of the film, the film carrier is rolled up on a subsequent roll for purposes of disposal.

22. The process of claims 1 through 21, wherein the carrier coated with the film is fed through additional processing or manipulation.

23. The process of claims 1 through 22, wherein the carrier is printed on prior to being coated.

24. The process of claims 1 through 23, wherein before being applied to the carrier, the film is processed.

25. The process of claim 24, wherein the film is laser-treated, perforated, stamped or treated in another manner.

26. The process of claims 1 through 25, wherein prior to being applied to the carrier, the film is printed on, on the side facing the carrier.

27. The process of claims 1 through 26, wherein flat objects are bound in with the application of the film.

28. The process of claim 27, wherein the flat objects are information carriers of any type, including texts, images, holograms, coils, and transponders.

29. A device for the application of a film onto a carrier, including onto a plastic card, wherein the carrier is at least partially irreversibly coated by the film, characterized by:
a. a gluing station, at which the carrier, the film, or both are coated by a thin layer of a transparent adhesive hardening under the action of electromagnetic waves;
b. a joining station wherein the carrier and the film are united, and;
c. a hardening station wherein the adhesive is hardened under the action of electromagnetic waves including under the action of light.

30. The device of claim 29, wherein a reserve supply is provided to supply the carrier from which the carrier is preferably fed in linear fashion to the stations.

31. The device of claims 29 through 30, wherein a reserve supply preferably embodied as a roll is provided to supply the film and wherein the film can be unrolled preferably on a band-shaped film carrier and can be fed to the stations.

32. The device of claim 31, wherein for disposal of the film carrier, a reserve, in one embodiment a roll, is provided onto which the film carrier can be rolled up after being lifted off the glued film.

33. The device of claims 29 through 32, wherein for processing the film, a processing station is provided, in one embodiment before the gluing station or before the joining station.

34. The device of claims 29 through 33, wherein a printing station is provided for printing on the carrier, on the film, or on both.
